(19) United States
(12) Patent Application Publication
(10) Pub. No.: US 2014/0312642 A1
(43) Pub. Date: Oct. 23, 2014

(54) LINER AND LINER SYSTEM FOR MACHINE BODY

(71) Applicant: CATERPILLAR INC., Peoria, IL (US)

(72) Inventors: Aaron K. Amstutz, Peoria, IL (US); Daniel R. Hettinger, Monticello, IL (US)

(73) Assignee: Caterpillar Inc., Peoria, IL (US)

(21) Appl. No.: 13/865,314

(22) Filed: Apr. 18, 2013

(51) Int. Cl. B60P 1/28; B60R 13/01

(52) U.S. Cl. CPC B60P 1/286; B60R 13/01
USPC 296/39.2; 427/379

(57) ABSTRACT

A liner for a machine body includes a first layer including a first polyurethane having first material characteristics, and a second layer coupled to the first layer. The second layer includes a second polyurethane having second material characteristics different than the first material characteristics, and the first layer and the second layer are chemically bonded to one another. A liner system includes a liner and a liner retention system configured to couple the liner to the machine body. The liner retention system includes at least one retention strip configured to be coupled to the machine body. The retention strip has a cross-section forming a lateral profile. At least one edge of the liner has a shape configured to substantially correspond to the lateral profile of the retention strip.

### TECHNICAL FIELD

The present disclosure relates to liners and liner systems for machine bodies, and more particularly, to liners and liner systems including those formed from polyurethane.

### BACKGROUND

Machines such as off-highway trucks may be used to carry material excavated from the earth or from other sources such as scrap yards. For example, such machines may have material-carrying bodies configured to receive, carry, and deposit such material. The material may be transferred to the machine by earth moving machines such as excavators and loaders, which use buckets to dump the material into the machine body. The repeated process of receiving the dumped material and depositing the material may result in premature wear of the machine body due to the impact of the material as it is dumped into the machine body and slides against the body as it is deposited from the machine. Therefore, it may be desirable to provide the machine body with a liner to protect the machine body from premature wear.

It may be desirable for a liner to have a combination of properties. For example, it may be desirable for a liner to be cut- and chip-resistant, abrasion resistant, have a low coefficient of friction, and have a superior fatigue life. This may prevent excessive wear as the material is deposited into the machine body and is evacuated from the machine body. In addition, it may be desirable for the liner to be deformable, have a relatively low modulus, and have a relatively high energy absorbing capacity, for example, to protect the machine from shock as the material is being deposited into the machine body.

It may also be desirable to provide a liner retention system that provides a secure coupling between the liner and the machine body to prevent the liner from unintentionally sliding out of the machine body during dumping of the material from the machine body. In addition, it may be desirable for such a system to be relatively lightweight to avoid unnecessarily increasing the weight in the machine body. It may also be desirable to provide a system that is relatively easily and inexpensively installed or replaced.

An example of a protective overlay for a truck box is disclosed in U.S. Pat. No. 4,029,354 to Valeri (“the '354 patent”). In particular, the '354 patent discloses a pair of elongated anchors having a Z-shaped cross-section, each having one flange embedded in an elastomeric block and the other flange welded to the truck box. The sides of each elastomeric block are angled so as to form a converging slot between adjacent blocks. An elongated strip of elastomeric material softer than the blocks is pressed into each slot to create a generally flush relation with the blocks. According to the '354 patent, the elastomeric material may be polyurethane, and the blocks may be used to completely cover the surface of the truck box to be protected.

Although the protective overlay disclosed in the '354 patent may provide some level of protection for the truck box, it may suffer from a number of possible drawbacks. For example, the elastomeric blocks may not provide a desirable combination of characteristics for a machine bed liner. For example, the overlay may not provide a combination of one or more of cut- and chip-resistance, abrasion resistance, a low coefficient of friction, and superior fatigue life. It may also not provide one or more of a desired level deformability, a relatively low modulus, and a relatively high energy absorbing capacity. In addition, by virtue of the anchors being welded to the truck box, the overlay of the '354 patent may be relatively complex or expensive to install or replace.

The liner and liner system disclosed herein may be directed to mitigating or overcoming one or more of the possible drawbacks set forth above.

### SUMMARY

According to a first aspect, the present disclosure is directed to a liner for a machine body. The liner may include a first layer including a first polyurethane having first material characteristics, and a second layer coupled to the first layer. The second layer may include a second polyurethane having second material characteristics different than the first material characteristics, wherein the first layer and the second layer are chemically bonded to one another. For example, the first layer may be a top layer, and the first layer may have a Shore hardness ranging from about 80A to about 98A. According to a further aspect, the second layer may be a base layer, and the second layer may have a Shore hardness ranging from about 50A to about 80A.

According to still a further aspect, the liner may further include an interlayer between the first layer and the second layer, wherein the interlayer may include a third polyurethane, and wherein the first layer and the second layer may be chemically bonded to one another via the interlayer. For example, the interlayer may have a Shore hardness ranging from about 75A to about 85A.

According to yet another aspect, the liner may further include a third layer coupled to the first layer, wherein the third layer may include a third polyurethane having third material characteristics different than the first material characteristics. For example, the third layer may be a top layer, and the third layer may have a Shore hardness ranging from about 80A to 98A. According to a further aspect, the first layer may be an intermediate layer, the first layer may have a Shore hardness ranging from about 55A to about 75A, and the second layer may be a base layer.

According to still a further aspect, the liner may further include an interlayer between the first layer and the third layer, wherein the interlayer includes a fourth polyurethane, and wherein the first layer and the third layer are chemically bonded to one another via the interlayer. For example, the interlayer may have a Shore hardness ranging from about 75A to about 85A.

According to yet another aspect, the liner may further include a second interlayer between the second layer and the first layer, wherein the second interlayer includes a fifth polyurethane having fifth material characteristics. For example, the second layer may be a base layer, the first layer may be an intermediate later layer, and the third layer may be a top layer. According to still another aspect, the second layer may be harder than the first layer, and the third layer may be harder than the first layer.

According to a further aspect, the liner may further include a composite layer coupled to the second layer, wherein the third layer may include a metallic layer. According to another aspect, the composite layer may further include a third polyurethane. For example, the metallic layer may be a first metallic layer, the composite layer may further include a second metallic layer, and the third polyurethane may be sandwiched between the first metallic layer and the second metallic layer. According to still another aspect, the liner may further include an interlayer between the first layer and the second layer, wherein the interlayer includes a fourth polyurethane, wherein the first layer and the second layer may be chemically bonded to one another via the interlayer.

According to a further aspect, the present disclosure is directed to a liner system for a machine body. The liner system may include a liner including a first layer including a first polyurethane having first material characteristics, and a second layer coupled to the first layer. The second layer may include a second polyurethane having second material characteristics different than the first material characteristics. The first layer and the second layer may be chemically bonded to one another. The liner system may also include a liner retention system configured to couple the liner to the machine body. The liner retention system may include at least one retention strip configured to be coupled to the machine body. The retention strip may have a cross-section including a base portion, an intermediate portion, and a head portion forming a lateral profile. The base portion may have a base width, and the head portion may have head width, wherein the base width and head width are greater than an intermediate width of the intermediate portion. At least one edge of the liner may have a shape configured to substantially correspond to the lateral profile of the retention strip.

According to another aspect, the retention system may further include a coupling system associated with the base portion, and the coupling system may be configured to couple the retention strip to the machine body. For example, the coupling system may include at least one of adhesive, double-sided tape, a hook and loop fastener system, and fasteners.

According to yet another aspect, the present disclosure is directed to a method of making a liner for a machine body. The method may include forming a first layer including a first polyurethane having first material characteristics, and partially curing the first polyurethane. The method may further include forming a second layer including a second polyurethane having second material characteristics different than the first material characteristics. The method may also include heating the first and second layers for a sufficient time to cure the first and second polyurethanes, such that the first and second layers are chemically bonded to one another. For example, heating the first and second layers may result in the first and second layers being covalently bonded to one another.

According to another aspect, the method may further include forming an interlayer between the first layer and the second layer, wherein the interlayer includes a third polyurethane. The method may further include partially curing the interlayer, and heating the first layer, the second layer, and the interlayer for a sufficient time to cure the first, second, and third polyurethanes, such that the first and second layers are chemically bonded to one another via the interlayer. According to another aspect, the interlayer may be formulated to range from 50% to 90% stoichiometric.

According to yet another aspect, the method may further include forming a third layer coupled to the first layer, wherein the third layer includes a third polyurethane having third material characteristics different than the first material characteristics. The method may further include heating the first, second, and third layers for a sufficient time to cure the first, second, and third polyurethanes, such that the first and third layers are chemically bonded to one another.

According to another aspect, the method may further include forming an interlayer between the first layer and the third layer, wherein the interlayer includes a fourth polyurethane. The method may also include partially curing the interlayer, and heating the first layer, second layer, third layer, and interlayer for a sufficient time to cure the first, second, third, and fourth polyurethanes, such that the first and third layers are chemically bonded to one another via the interlayer. According to a further aspect, the method may further include forming a second interlayer between the second layer and the first layer, wherein the second interlayer includes a fifth polyurethane having fifth material characteristics. The method may further include partially curing the second interlayer, and heating the first layer, second layer, third layer, interlayer, and second interlayer for a sufficient time to cure the first, second, third, fourth, and fifth polyurethanes, such that the first and second layers are chemically bonded to one another via the second interlayer.

### BRIEF DESCRIPTION OF THE DRAWINGS

FIG. 1 is a side view of an exemplary embodiment of a machine.

FIG. 2 is a perspective view of an exemplary embodiment of a machine body.

FIG. 3 is a schematic section view of an exemplary embodiment of a liner for a machine body.

FIG. 4 is a schematic section view of another exemplary embodiment of a liner for a machine body.

FIG. 5 is a schematic section view of another exemplary embodiment of a liner for a machine body.

FIG. 6 is a schematic section view of another exemplary embodiment of a liner for a machine body.

FIG. 7 is a perspective view of an exemplary embodiment of a liner system for a machine body.

FIG. 8 is a section view of an exemplary embodiment of a retention system and exemplary liner.

### DETAILED DESCRIPTION

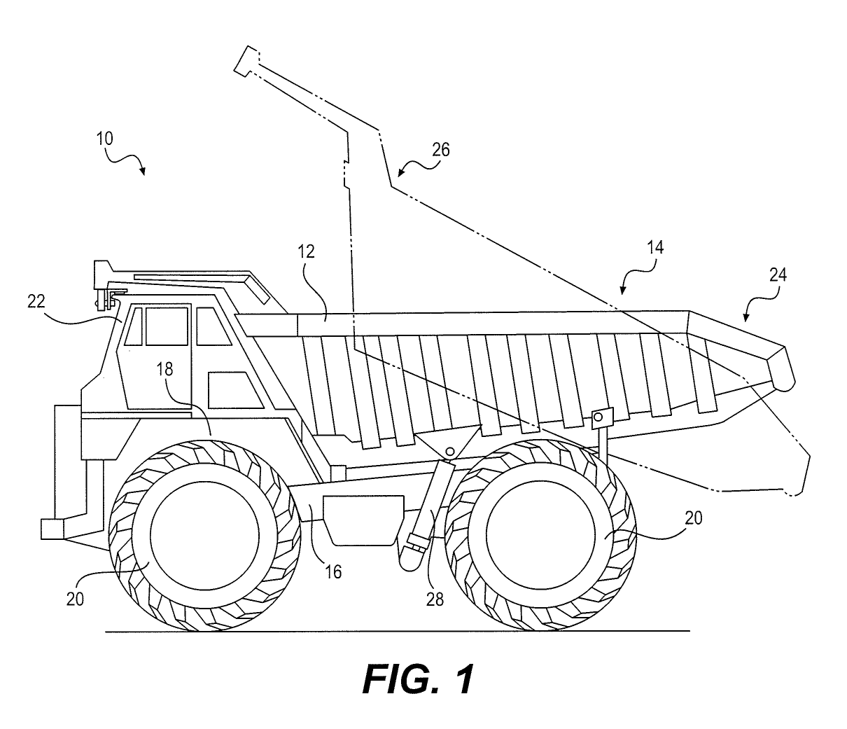

FIG. 1 shows an exemplary machine 10 configured to receive, transport, and deposit a load of material associated with, for example, mining, earthmoving, and construction purposes. Exemplary machine 10 shown in FIG. 1 is an off-highway truck having an exemplary body 12 having a bed 14 for receiving, transporting, and depositing a load of material. However, machine 10 may be any type of ground-borne vehicle having a bed, such as, for example, an on-highway truck and/or any other similar vehicle type known to a person skilled in the art.

As shown in FIG. 1, machine 10 has a chassis 16 and a powertrain 18 coupled to and configured to supply power to wheels 20, so that machine 10 is able to travel across terrain. Machine 10 also includes a cab 22 to provide an operator interface to control operation of machine 10 and to provide protection for an operator of machine 10. As shown in FIG. 1, body 12 is coupled to chassis 16 such that body 12 may tilt between a relatively horizontal position 24 for receiving and carrying a load of material, and a relatively upright position 26 (shown in phantom lines) for dumping a load of material. Machine 10 may include one or more actuators 28 configured to facilitate tilting of body 12.

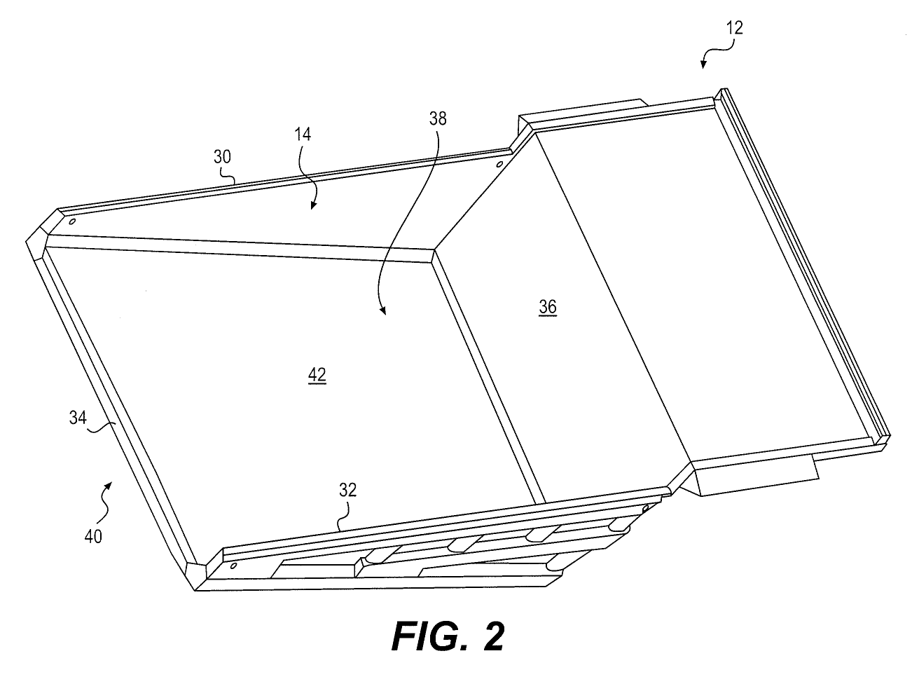

As shown in FIG. 2, exemplary bed 14 includes a pair of side walls 30 and 32 on opposite lateral sides of a floor 34, and an end wall 36 for protecting cab 22 from material in bed 14. Bed 14 may be configured and dimensioned to define a cavity 38 based on considerations such as, for example, the type of load desired to be carried. For example, although exemplary cavity 38 has a relatively planar floor 34, other configurations such as a V-shaped floor 34 are contemplated. Exemplary cavity 38 has a rear opening 40 through which material may traverse upon tilting of body 12 to a relatively upright position 26, such that material is evacuated from bed 14. According to some embodiments, a gate (not shown) may be provided at rear opening 40 to prevent material from unintentionally exiting bed 14.

As shown in FIG. 2, body 12 includes a liner 42 configured to protect bed 14 and/or promote sliding of material as the material is evacuated from bed 14 when body 12 is tilted to its relatively upright position 26 during dumping of the material from bed 14. As shown in FIG. 2, exemplary liner 42 substantially covers floor 34 of bed 14. According to some embodiments, liner 42 may cover less than the entire area of floor 34. According to some embodiments, liner 42 may cover some or all of one or more of side walls 30 and 32 and end wall 36.

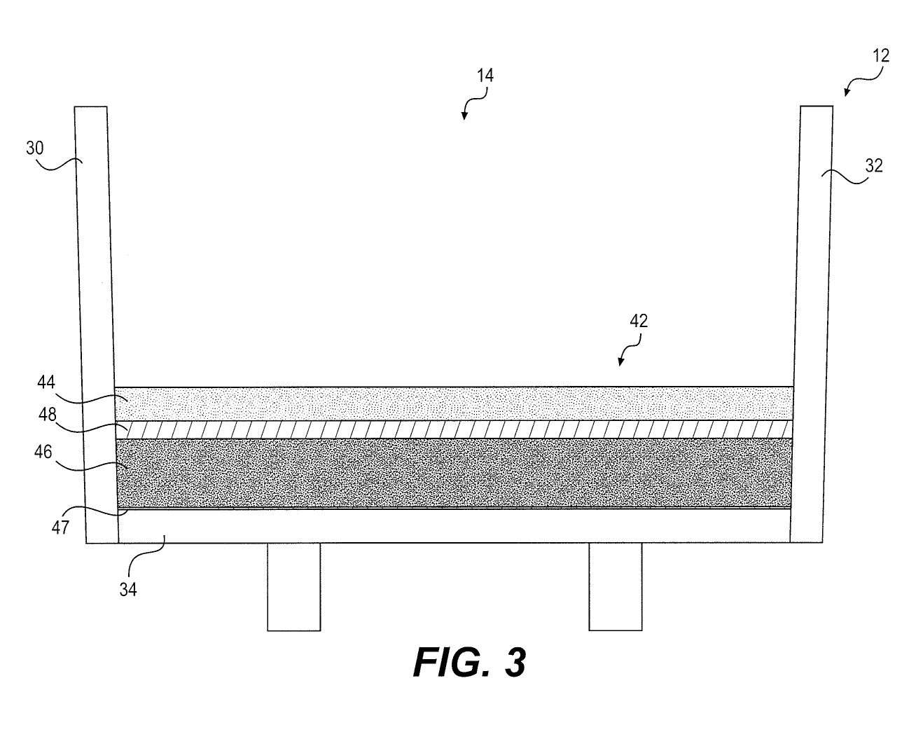

FIG. 3 schematically depicts an exemplary embodiment of liner 42 provided over floor 34 and between opposing side walls 30 and 32 of body 12. As shown in FIG. 3, exemplary liner 42 includes more than one layer of material, which provides the ability to tailor the characteristics of liner 42 to achieve a desired performance of liner 42.

For example, as shown in FIG. 3, liner 42 includes a first layer 44 including a first polyurethane having first material characteristics, and a second layer 46 including a second polyurethane having second material characteristics different than the first material characteristics. According to some embodiments, first layer 44 may be a polyurethane wear layer, and second layer 46 may be an impact-absorbing polyurethane. According to some embodiments, the first polyurethane of first layer 44 may have a Shore hardness ranging from about 80A to about 98A (e.g., from about 85A to about 95A), and the second polyurethane of second layer 46 may have a Shore hardness ranging from about 50A to about 80A (e.g., from about 55A to about 75A). Thus, first layer 44 may be relatively harder than second layer 46. This exemplary combination may result in desirable characteristics for liner 42 such as, for example, first layer 44 having desirable cut and chip resistance, abrasion resistance, fatigue life, and a relatively low coefficient of friction to promote sliding of material in bed 14 when dumping the material. This combination may also result in second layer 46 having desirable deformability, a relatively low modulus, a relatively high energy absorbing capacity, and relatively lower cost. Second layer 46 may serve to absorb the impact of material such as large rocks falling into bed 14. It is contemplated that second layer 46 may have other material characteristics tailored to the desired use of machine 10. For example, if machine 10 is intended to carry coal, which is relatively smaller and lighter than, for example, large rocks, second layer 46 may be formed from a material having lower energy absorbing characteristics.

As used herein, the terms “first,” “second”, “third,” etc., and forms thereof, are not necessarily indicative of order. Rather, these terms are used primarily to differentiate between different layers and different materials.

According to some embodiments, first layer 44 may be a top layer, and second layer 46 may be a base layer. First layer 44 and second layer 46 may be coupled to one another such that first layer 44 and second layer 46 are chemically bonded to one another (e.g., the first polyurethane of first layer 44 is covalently bonded to the second polyurethane of second layer 46). For example, at least some of the first polyurethane of first layer 44 is covalently bonded to at least some of the second polyurethane of second layer 46. This may result in a superior bond than bonds formed via adhesives, mechanisms, or fasteners. According to some embodiments, first layer 44 and second layer 46 are coupled directly to one another (i.e., they are in direct contact with one another). According to some embodiments, bed 14 may be formed from steel or another similar material, and second layer 46 may be coupled to bed 14 (e.g., floor 34) with adhesive 47. According to some embodiments, second layer 46 may be coupled to bed 14 via coupling systems and/or fasteners, as explained in more detail herein.

As shown in FIG. 3, some embodiments of liner 42 may include an interlayer 48 between first layer 44 and second layer 46. Interlayer 48 may include a third polyurethane, and first layer 44 and second layer 46 may be chemically bonded to one another via interlayer 48. For example, the first polyurethane of first layer 44 may be chemically bonded to the third polyurethane of interlayer 48, and the third polyurethane of interlayer 48 may be chemically bonded to the second polyurethane of second layer 46. The chemical bonds may be covalent bonds.

According to some embodiments, second layer 46 may be formed from a second polyurethane that is relatively soft in order to absorb impact of rocks falling into bed 14. For example, second layer 46 may be formulated with polyurethane polyether prepolymers, such as, for example, ADIPRENE® L 42, ADIPRENE® LW 520, or VIBRATHANE® B625, or a similar material. Such prepolymers may be reacted with materials, such as, for example, DURACURE® C3-LF, or a similar material, at about 98% stoichiometry. That is, in a polyurethane urea system there is a theoretical point where each isocyanate group will react with each curative (amine) functional group. Such a point would be considered to correspond to a stoichiometry of 100%. In a case where excess curative (diamine) is added, the stoichiometry would be considered to be greater than 100%. In a case where less curative is added, the stoichiometry would be considered to be less than 100%. For example, if a polyurethane part is formed with a stoichiometry less than 100%, there will be excess isocyanate functionality remaining in the part. Upon high temperature postcuring of such a part (e.g., subjecting the part to a second heating cycle following an initial, incomplete curing), the excess isocyanate groups will react to form urea linkages, biuret linkages, and isocyanurates through cyclo-trimerization, or crosslinks through allophanate formation.

According to some embodiments, the second polyurethane of second layer 46 is supplied to a liner mold and is partially cured by heating second layer 46 for a time and temperature sufficient to partially cure the second polyurethane (e.g., a temperature ranging from about 110° C. to about 140° C. for a duration ranging from about 1 hour to about 4 hours). This partial curing may result in the second polyurethane becoming at least gel-like, but not necessarily completely solidified.

Thereafter, the third polyurethane of interlayer 48 may be cast over the partially cured second layer 46. According to some embodiments, the third polyurethane may include materials, such as, for example, DURACAST® S900, DURACAST® C900, or DURACAST® C930, or a similar material. In addition, the third polyurethane may include, for example, a prepolymer mixed with DURACURE® C3-LF formulated to range from about 50% to about 90% of theoretical stoichiometry (i.e., from about 50% to about 90% “stoichiometric”) (e.g., from about 60% to about 80% stoichiometric (e.g., about 60% stoichiometric)). This exemplary formulation making up the third polyurethane may be cast over second layer 46, and the second and third polyurethanes may be heated for a time and temperature sufficient to partially cure the third polyurethane (e.g., at a temperature ranging from about 110° C. to about 140° C. for a duration ranging from about 0.5 hour to about 2 hours, for example, for interlayer 48 being relatively thinner than second layer 46). This partial curing of interlayer 48 allows for initial chemical reactions of the third polyurethane constituents, so that the third polyurethane is gel-like, while retaining residual reactivity.

Following partial curing of interlayer 48, first layer 44 may be cast over interlayer 48. For example, the first polyurethane of first layer 44 may include the same materials as the third polyurethane of interlayer 48, but formulated at about 98% stoichiometry instead of the about 50% to about 90% stoichiometry of third polyurethane. Following the casting of the first polyurethane over interlayer 48, first layer 44, interlayer 48, and second layer 46 may be postcured by heating at a temperature ranging from about 120° C. to about 160° C. for a duration ranging from about 6 hours to about 24 hours. Thereafter, liner 42 may be removed from the liner mold.

During the final postcuring stage, the third polyurethane of interlayer 48 reacts chemically with the first and second polyurethanes of first layer 44 and second layer 46 to provide chemical bonds, so that first layer 44, interlayer 48, and second layer 46 are joined together to form a single, monolithic liner 42 while substantially maintaining the respective different material characteristics of first layer 44 and second layer 46. Interlayer 48 may serve to bridge the modulus gradient between first layer 44 and second layer 46. For example, if interlayer 48 is formulated with prepolymers that would normally result in a cured polyurethane having a Shore hardness ranging from about 90A to about 95A when formulated at 98% stoichiometry, interlayer 48 may be expected to have a Shore hardness ranging from about 75A to about 85A when cured according to the example above. Intermediate layer 48, having a stoichiometry ranging from about 50% to about 90% (e.g., about 60%), has sufficient curative to gel when first cast and heated, but the residual isocyanate groups will not react further until subjected to higher temperatures for longer durations occurring during postcuring. The residual isocyanate groups will react with urethane linkages in both first layer 44 and second layer 46 to form allophonate crosslinking, and the residual isocyanate groups will react within intermediate layer 48 to form allophonate crosslinking as well as biuret dimerization and isocyanurate cyclo-trimerization.

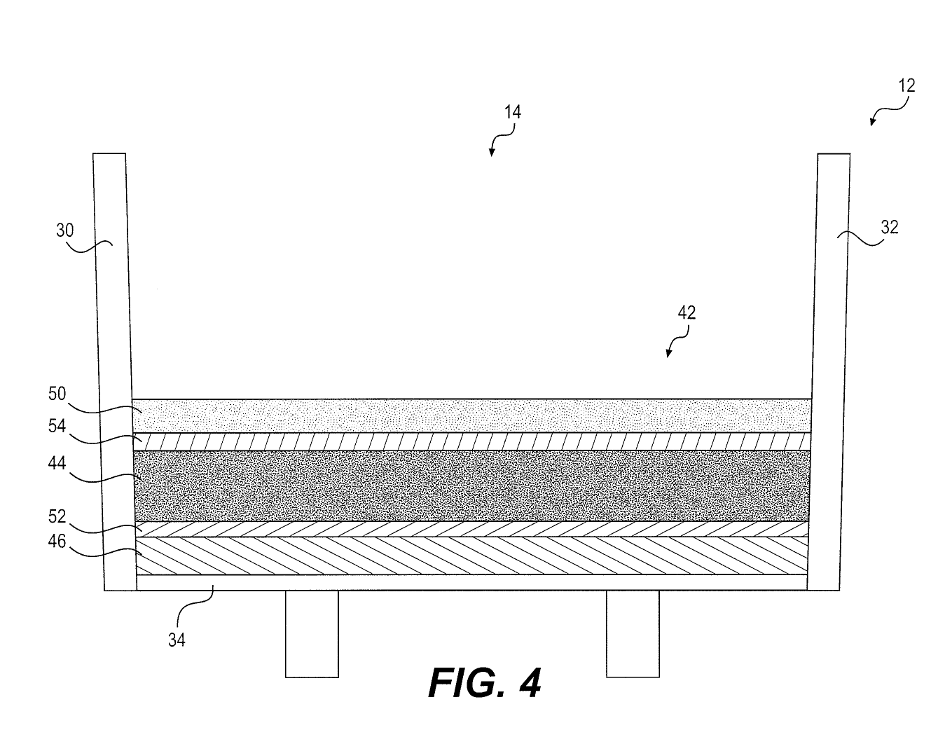

As shown in FIG. 4, some embodiments of liner 42 may include a third layer 50 including a third polyurethane. For example, as shown in FIG. 4 exemplary liner 42 includes first layer 44 coupled to second layer 46, with third layer 50 coupled to first layer 44. According to some embodiments, first layer 44 may be an impact-absorbing polyurethane, second layer 46 may be a polyurethane structural composite, and third layer 50 may be a polyurethane wear layer. According to some embodiments, second layer 46 may be a base layer including a second polyurethane, for example, in the form of a rigid polyurethane structural composite. First layer 44 may be an intermediate layer and may include a first polyurethane, for example, having a Shore hardness ranging from about 50A to about 80A, which may be a relatively low cost, impact absorbing polyurethane. Third layer 50 may be a top layer and may include third polyurethane, which may have, for example, a Shore hardness ranging from about 80A to about 98A, which may provide a relatively high performance polyurethane wear layer.

According to some embodiments, first layer 44 and third layer 50 may be chemically bonded (e.g., covalently bonded) to one another, and first layer 44 and second layer 46 may be chemically bonded to one another, such that liner 42 is a single, monolithic structure. According to the exemplary embodiment shown in FIG. 4, first layer 44 and second layer 46 are coupled to one another via interlayer 52, and first layer 44 and third layer 50 are coupled to one another via a second interlayer 54. According to some embodiments, first layer 44 and second layer 46 are chemically bonded to one another via interlayer 52, and first layer 44 and third layer 50 are chemically bonded to one another via a second interlayer 54, such that liner 42 is a monolithic structure. By virtue of chemical bonding between the layers and interlayers, the likelihood that the layers and interlayers become separated from one another may be reduced relative to layers of polyurethane that are secured to one another via adhesives.

According to some embodiments, exemplary liner 42 shown in FIG. 4 may be formed in a manner similar to the exemplary manner in which the exemplary liner 42 shown in FIG. 3 is formed. For example, one or more of interlayer 52 and second interlayer 54 may be formulated so that they are about 50% to about 90% stoichiometric (e.g., from about 60% to about 80% stoichiometric (e.g., about 60% stoichiometric)). The second polyurethane of second layer 46 is supplied to a liner mold and is partially cured by heating second layer 46 for a time and temperature sufficient to partially cure the second polyurethane (e.g., a temperature ranging from about 110° C. to about 140° C. for a duration ranging from about 1 hour to about 4 hours). This partial curing may result in the second polyurethane becoming at least gel-like, but not necessarily completely cured. The second polyurethane may be selected to provide structural rigidity associated with polyurethane composite materials having a Shore hardness, for example, ranging from about 55D to about 90D, and may include reinforcing materials such as, for example, glass fiber, carbon fiber, mineral filler, or other reinforcements known to those skilled in the art.

Thereafter, the polyurethane of interlayer 52 may be cast over the partially cured second layer 46. According to some embodiments, the polyurethane of interlayer 52 may include a material content similar to first polyurethane of first layer 44, except with a stoichiometry ranging from about 50% to about 90% (e.g., 60%). The second polyurethane of second layer 46 and the polyurethane of interlayer 52 may be heated for a time and temperature sufficient to partially cure the polyurethane of interlayer 52 (e.g., at a temperature ranging from about 110° C. to about 140° C. for a duration ranging from about 0.5 hour to about 2 hours).

Following partial curing of interlayer 52, first layer 44 may be cast over interlayer 52. For example, the first polyurethane of first layer 44 may include the same materials as interlayer 52, but formulated at about 98% stoichiometry instead of about 50% to about 90% stoichiometry. Following the casting of the first polyurethane over interlayer 52, first layer 44, interlayer 52, and second layer 46 may be partially cured by heating for a time and temperature sufficient to partially cure the first polyurethane (e.g., a temperature ranging from about 110° C. to about 140° C. for a duration ranging from about 1 hour to about 4 hours). This partial curing may result in the first polyurethane of first layer 44 becoming at least gel-like, but not necessarily completely cured.

Thereafter, the polyurethane of second interlayer 54 may be cast over the partially cured first layer 46. According to some embodiments, the polyurethane of second interlayer 54 may include a material content similar to the third polyurethane of third layer 50, except with a stoichiometry ranging from about 50% to about 90% (e.g., 60%). The polyurethane of second interlayer 54 may be heated for a time and temperature sufficient to partially cure the polyurethane of second interlayer 54 (e.g., at a temperature ranging from about 110° C. to about 140° C. for a duration ranging from about 0.5 hour to about 2 hours).

Following the partial curing of second interlayer 54, third layer 50 may be cast over second interlayer 54. For example, the third polyurethane of third layer 50 may include the same materials as second interlayer 54, but formulated at about 98% stoichiometry instead of about 50% to about 90% stoichiometry.

Following the casting of the third polyurethane over second interlayer 54, third layer 50, second interlayer 54, first layer 44, interlayer 52, and second layer 46 may be postcured by heating at a temperature ranging from about 120° C. to about 160° C. for a duration ranging from about 6 hours to about 24 hours. Thereafter, liner 42 may be removed from the liner mold.

This exemplary process for forming the exemplary liner 42 shown in FIG. 4 may result in the layers and interlayers of liner 42 being chemically bonded to one another (e.g., covalently bonded to one another) to form a single, monolithic structure. By virtue of chemical bonding between the layers and interlayers, the likelihood that the layers and interlayers become separated from one another may be reduced relative to layers of polyurethane that are secured to one another via adhesives.

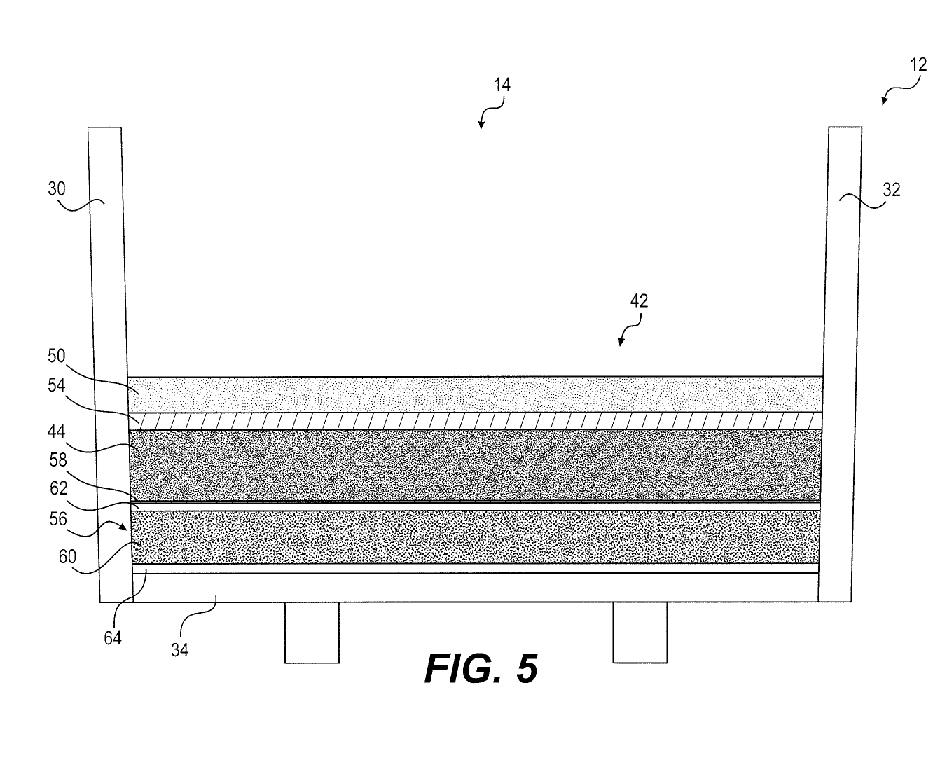

The exemplary embodiment of liner shown in FIG. 5 is similar to the exemplary embodiment shown in FIG. 4, except that second layer 46 and interlayer 52 shown in FIG. 4 have been replaced with a composite layer 56 and an adhesive 58. For example, as shown in FIG. 5 composite layer 56 includes a rigid polyurethane 60 sandwiched between two metallic layers 62 and 64. According to some embodiments, one or more of metallic layers 62 and 64 may include steel or another similar material. According to the embodiment shown in FIG. 5, adhesive 58 couples metallic layer 62 and first layer 44 to one another, and first layer 44, second interlayer 54, and third layer 50 are the same or similar to the corresponding portions of the exemplary liner 42 shown in FIG. 4. According to some embodiments, first layer 44 may be an impact-absorbing polyurethane, and third layer 50 may be a polyurethane wear layer. According to some embodiments, first layer 44, second interlayer 54, and third layer 50 shown in FIG. 5 may be formed in the same or in a similar manner as the corresponding portions of the exemplary liner 42 shown in FIG. 4. The exemplary liner 42 shown in FIG. 5 may provide bed 14 with additional protection, which may be useful when bed 14 is used to carry, for example, large, heavy rocks instead of, for example, relatively smaller, lighter coal. In some embodiments, composite layer 56 may have structural properties sufficient to allow for the construction of a truck bed without floor 34 of machine 10. In some embodiments, composite layer 56 may utilize floor 34 for the bottom metallic layer of its structure, for example, and metallic layer 64 may be unnecessary.

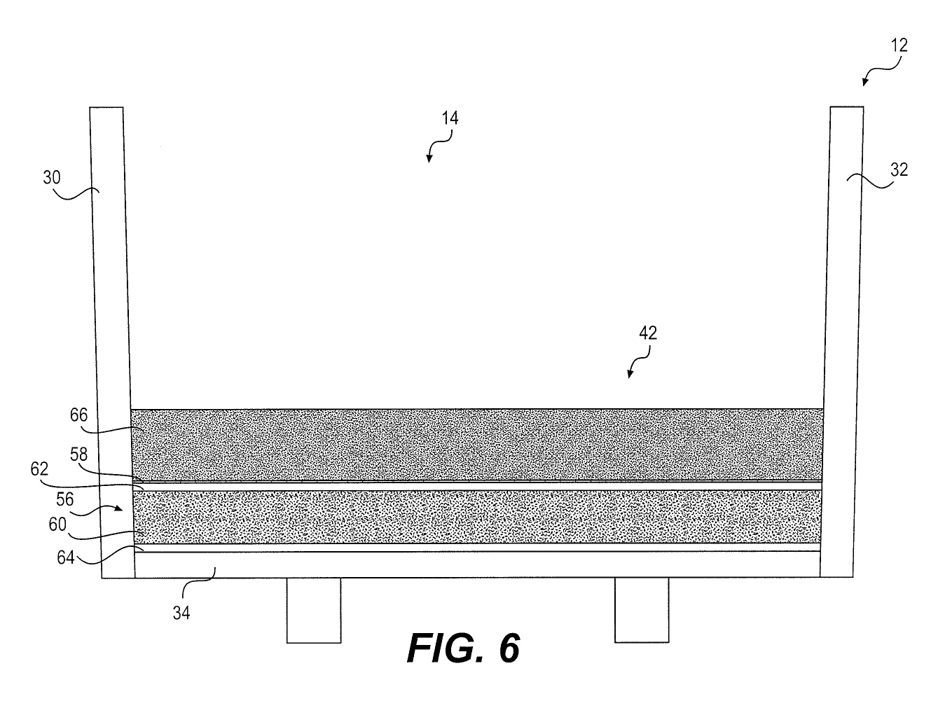

The exemplary embodiment of liner 42 shown in FIG. 6 is similar to the exemplary embodiment shown in FIG. 5, except that first layer 44, second interlayer 54, and third layer 50 shown in FIG. 5 have been replaced with a layer 66 of polyurethane. According to the embodiment shown in FIG. 6, liner 42 includes composite layer 56, including a rigid polyurethane 60 sandwiched between two metallic layers 62 and 64. According to some embodiments, one or more of metallic layers 62 and 64 may include steel or another similar material. According to the embodiment shown in FIG. 6, adhesive 58 couples metallic layer 62 and layer 66 of polyurethane to one another. Layer 66 may include, for example, a polyurethane having intermediate properties between those of the first layer 44 of FIG. 5 and third layer 50 of FIG. 5. For example, layer 66 may include a polyurethane having a Shore hardness ranging between about 75A and about 95A (e.g., 85A) to provide some level of impact absorbing properties while retaining sufficient wear resistance.

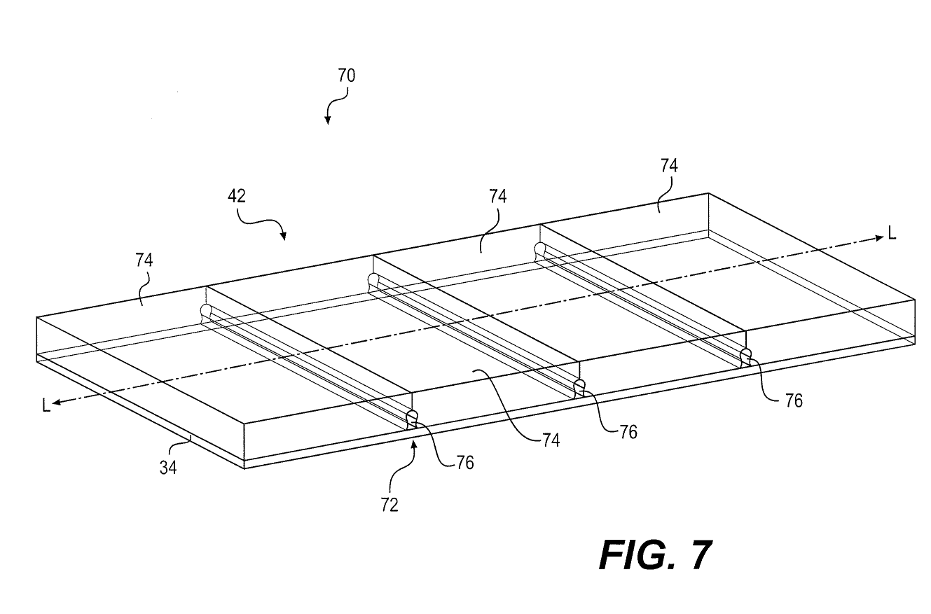

FIG. 7 shows an exemplary embodiment of a liner system 70 for a machine bed. As shown in FIG. 7, exemplary liner system 70 includes liner 42 and a liner retention system 72 configured to couple liner 42 to bed 14. Exemplary liner 42 includes a plurality of liner sections 74, each of which may be consistent with liner 42 described previously herein. FIG. 7 shows four liner sections 74, although fewer or more liner sections 74 are contemplated. Liner system 70 may be coupled to bed 14 such that liner 42 substantially covers floor 34 of bed 14. According to some embodiments, liner 42 may cover less than the entire area of floor 34. According to some embodiments, liner 42 may cover some or all of one or more of side walls 30 and 32 and end wall 36 of bed 14 (see FIG. 2).

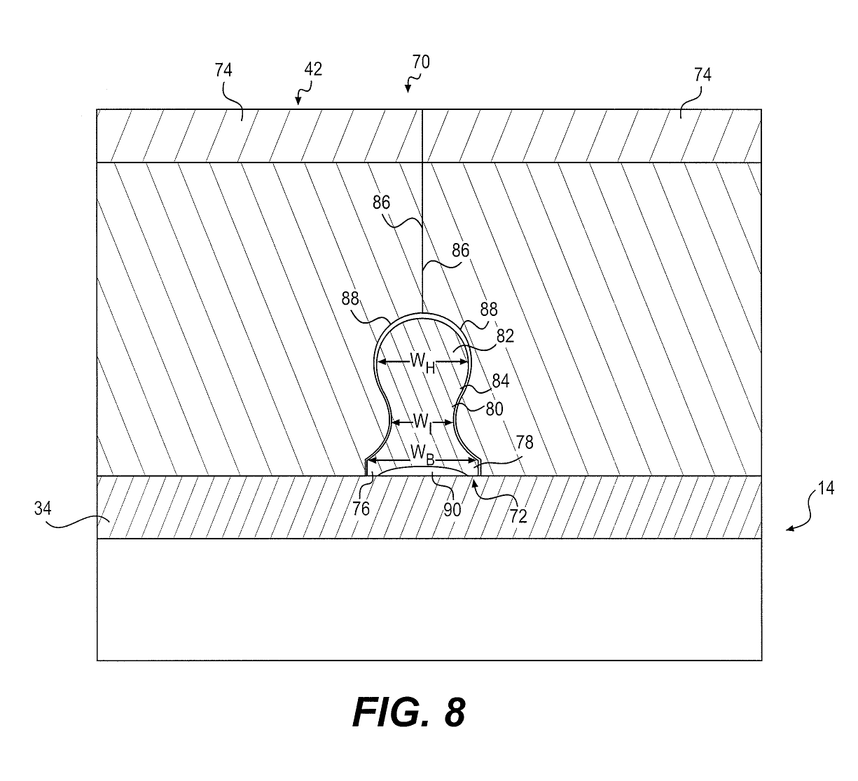

As shown in FIGS. 7 and 8, exemplary liner retention system 72 includes a plurality of retention strips 76 configured to be coupled to bed 14. According to some embodiments, retention strips 76 are coupled to bed 14 substantially perpendicular to the longitudinal axis L of bed 14 extending in the direction of the length of bed 14. This exemplary configuration may serve to prevent liner sections 74 from sliding out of rear opening 40 of bed 14 (see FIG. 2) when dumping material from bed 14. Some embodiments of liner retention system 72 may have a single retention strip 76.

As shown in FIG. 8, exemplary retention strips 76 have a cross-section including a base portion 78, an intermediate portion 80, and a head portion 82 forming a lateral profile 84. In the exemplary embodiment shown, base portion 78 has a base width W_{B}, head portion 82 has a head width W_{H}, and intermediate portion 80 had an intermediate width W_{I}. As shown, base width W_{B} and head width W_{H} are greater than an intermediate width W_{I}.

As shown in FIG. 8, at least one of the edges 86 of liner 42 has a shape configured to substantially correspond to lateral profile 84 of retention strips 76. As shown in FIG. 8, edges of two adjacent liner sections 74 meet at retention strip 76. This exemplary configuration may serve to hold liner sections 74 in place and prevent material from migrating under liner sections 74. According to some embodiments, edge 86 of liner sections 74 have an edge profile 88 that is slightly larger in the vertical direction than lateral profile 84 of retention strips 76. This exemplary configuration may serve to prevent a load of material in bed 14 from compressing liner sections 74 and transferring the load to retention strips 76. According to some embodiments, liner 42 may include cross-section channels intermediate the edges to accept additional retention strips 76. For example, it may be advantageous to have retention channels and retention strips, for example, every 30 centimeters or less, to prevent retention strips 76 from buckling or becoming dislodged from the bed 14.

According to the embodiment shown in FIG. 8, liner retention system 72 includes a coupling system 90 associated with base portion 78 of retention strips 76. Coupling system 90 is configured to couple retention strip 76 to bed 14. Coupling system 90 may include at least one of adhesive, double-sided tape, a hook and loop fastener system, and fasteners such as threaded fasteners. Other fastening mechanisms are contemplated. According to some embodiments, retention strips 76 and coupling system 90 may result in relative ease of installation of liner retention system 72 in bed 14 of machine 10. For example, retention strips 76 may be coupled to bed 14 spaced from each other a distance substantially corresponding to the length of liner sections 74, for example, to aid in edge alignment. Thereafter, liner sections 74 may be pressed into engagement between at least two retention strips 76, such that lateral profiles 84 of retention strips 76 engage with edge profiles 88 of liner sections 74. Intermediate retention strips 76 may be easily aligned with hidden retention channels in the bottom of liner 42, for example, when edge-located retention strips are also used.

### INDUSTRIAL APPLICABILITY

The liner and liner system disclosed herein may be used to protect a machine body of a machine having a bed configured to receive, transport, and deposit a load of material, for example, associated with mining, earthmoving, and construction purposes. Such machines include, for example, off-highway trucks and any type of ground-borne vehicles having a bed for receiving, transporting, and depositing a load of material.

According to at least some embodiments, the liner and liner system may provide a combination of desirable properties. For example, the liner and liner system may be cut- and chip-resistant, abrasion resistant, have a low coefficient of friction, and/or have a superior fatigue life. This may prevent excessive wear as the material is being evacuated from the machine body during dumping. By virtue of the liner having layers of polyurethane with different characteristics, such as, for example, hardness, modulus, and deformability, and energy absorbing capacity, it may be possible to provide a liner and liner system tailored to the desired use of the machine. For example, for a machine intended to be used to receive, carry, and deposit large rocks, it may be desirable to provide a liner and liner system having an upper layer with improved cut- and chip-resistance, combined with a lower layer providing improved energy absorbing capacity and protection of the machine bed. In contrast, for a machine intended to be used to receive, carry, and deposit coal or sand, it may be desirable to provide a liner and liner system having an upper layer with relatively lower cut- and chip-resistance, and a lower layer providing relatively lower energy absorbing capacity and protection for the machine bed. This may result in cost savings for such a liner and liner system.

In addition, at least some embodiments of the liner and liner system may have improved durability and a lengthened service life as a result of chemical bonding between polyurethane layers of the liner. Relative to the use of adhesive bonding, chemical bonding (e.g., covalent bonding) may improve the strength of the bond between polyurethane layers and/or interlayers of the liner. This may prevent or reduce the likelihood that the layers and interlayers separate from one another during repeated receipt and deposit of material from the machine bed.

In addition, according to at least some embodiments, the liner retention system may provide a secure coupling between the liner and the machine bed to prevent the liner from unintentionally sliding out of the machine bed during dumping of material. In addition, the liner retention system may be relatively lightweight when compared to other mechanisms used to hold liners in machine beds. This may avoid unnecessarily adding to the weight in the machine bed. The retention system according to at least some embodiments may also be relatively easily and inexpensively installed or replaced as compared to other systems, such as those that rely on welding to attach the liner to the machine bed.

It will be apparent to those skilled in the art that various modifications and variations can be made to the exemplary disclosed liner, liner system, and related methods. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. A liner for a machine body, the liner comprising:
a first layer including a first polyurethane having first material characteristics; and
a second layer coupled to the first layer, the second layer including a second polyurethane having second material characteristics different than the first material characteristics,
wherein the first layer and the second layer are chemically bonded to one another.

2. The liner of claim 1, wherein the first layer is a top layer, and the first layer has a Shore hardness ranging from about 80A to about 98A, and wherein the second layer is a base layer, and the second layer has a Shore hardness ranging from about 50A to about 80A.

3. The liner of claim 1, further including an interlayer between the first layer and the second layer, wherein the interlayer includes a third polyurethane, and wherein the first layer and the second layer are chemically bonded to one another via the interlayer.

4. The liner of claim 3, wherein the interlayer has a Shore hardness ranging from about 75A to about 85A.

5. The liner of claim 1, further including a third layer coupled to the first layer, wherein the third layer includes a third polyurethane having third material characteristics different than the first material characteristics.

6. The liner of claim 5, wherein the third layer is a top layer, and the third layer has a Shore hardness ranging from about 80A to 98A, and wherein the first layer is an intermediate layer, the first layer has a Shore hardness ranging from about 55A to about 75A, and the second layer is a base layer.

7. The liner of claim 5, further including an interlayer between the first layer and the third layer, wherein the interlayer includes a fourth polyurethane, wherein the first layer and the third layer are chemically bonded to one another via the interlayer, and wherein the interlayer has a Shore hardness ranging from about 75A to about 85A.

8. The liner of claim 7, further including a second interlayer between the second layer and the first layer, wherein the second interlayer includes a fifth polyurethane having fifth material characteristics.

9. The liner of claim 8, wherein the second layer is a base layer, the first layer is an intermediate later layer, and the third layer is a top layer, and wherein the second layer is harder than the first layer, and the third layer is harder than the first layer.

10. The liner of claim 1, further including a composite layer coupled to the second layer, wherein the third layer includes a metallic layer, and wherein the composite layer further includes a third polyurethane.

11. The liner of claim 10, wherein the metallic layer is a first metallic layer, the composite layer further includes a second metallic layer, and the third polyurethane is sandwiched between the first metallic layer and the second metallic layer, and the liner further includes an interlayer between the first layer and the second layer, wherein the interlayer includes a fourth polyurethane, and wherein the first layer and the second layer are chemically bonded to one another via the interlayer.

12. A liner system for a machine body, the liner system comprising:
a liner including:
a first layer including a first polyurethane having first material characteristics; and
a second layer coupled to the first layer, the second layer including a second polyurethane having second material characteristics different than the first material characteristics,
wherein the first layer and the second layer are chemically bonded to one another; and
a liner retention system configured to couple the liner to the machine body, the liner retention system including at least one retention strip configured to be coupled to the machine body,
wherein the retention strip has a cross-section including a base portion, an intermediate portion, and a head portion forming a lateral profile,
wherein the base portion has a base width and the head portion has a head width, and
wherein the base width and head width are greater than an intermediate width of the intermediate portion, and wherein at least one edge of the liner has a shape configured to substantially correspond to the lateral profile of the retention strip.

13. The liner system of claim 12, wherein the retention system further includes a coupling system associated with the base portion, and the coupling system is configured to couple the retention strip to the machine body.

14. The liner system of claim 13, wherein the coupling system includes at least one of adhesive, double-sided tape, a hook and loop fastener system, and fasteners.

15. A method of making a liner for a machine body, the method comprising:
forming a first layer including a first polyurethane having first material characteristics;
partially curing the first polyurethane; and
forming a second layer including a second polyurethane having second material characteristics different than the first material characteristics; and
heating the first and second layers for a sufficient time to cure the first and second polyurethanes, such that the first and second layers are chemically bonded to one another.

16. The method of claim 15, wherein heating the first and second layers results in the first and second layers being covalently bonded to one another.

17. The method of claim 15, further including:
forming an interlayer between the first layer and the second layer, wherein the interlayer includes a third polyurethane;
partially curing the interlayer; and
heating the first layer, the second layer, and the interlayer for a sufficient time to cure the first, second, and third polyurethanes, such that the first and second layers are chemically bonded to one another via the interlayer,
wherein the interlayer is formulated to range from 50% to 90% stoichiometric.

18. The method of claim 15, further including:
forming a third layer coupled to the first layer, wherein the third layer includes a third polyurethane having third material characteristics different than the first material characteristics; and
heating the first, second, and third layers for a sufficient time to cure the first, second, and third polyurethanes, such that the first and third layers are chemically bonded to one another.

19. The method of claim 18, further including:
forming an interlayer between the first layer and the third layer, wherein the interlayer includes a fourth polyurethane;
partially curing the interlayer; and
heating the first layer, second layer, third layer, and interlayer for a sufficient time to cure the first, second, third, and fourth polyurethanes, such that the first and third layers are chemically bonded to one another via the interlayer.

20. The method of claim 19, further including:
forming a second interlayer between the second layer and the first layer, wherein the second interlayer includes a fifth polyurethane having fifth material characteristics;
partially curing the second interlayer; and
heating the first layer, second layer, third layer, interlayer, and second interlayer for a sufficient time to cure the first, second, third, fourth, and fifth polyurethanes, such that the first and second layers are chemically bonded to one another via the second interlayer.
